(19) United States
(12) Patent Application Publication
(10) Pub. No.: US 2012/0144624 A1
(43) Pub. Date: Jun. 14, 2012

(54) DOOR STOP ASSEMBLY HAVING AN INTERCHANGEABLE DECORATIVE HEAD PIECE

(75) Inventors: Caroline SWARTZ, Charlotte, NC (US); Todd Arthur WAGGONER, Cameron, WI (US)

(73) Assignee: DECO DOOR STOP, INC., Huntersville, NC (US)

(21) Appl. No.: 13/397,915

(22) Filed: Feb. 16, 2012

Related U.S. Application Data
(63) Continuation-in-part of application No. 12/508,739, filed on Jul. 24, 2009, now abandoned.

(51) Int. Cl. E05F 5/02; B23P 17/04

(52) U.S. Cl. 16/82; 29/428

(57) ABSTRACT

The present invention provides a door stop assembly having an interchangeable decorative head piece, including: a base plate that is selectively secured to the base of a wall; a retention bracket that is selectively secured to the base plate; a stem portion that protrudes from the retention bracket; and a decorative head piece that is selectively secured to the retention bracket. Optionally, the base plate and the retention bracket are integrally formed. Optionally, the base plate and the retention bracket define a space there between. The decorative head piece includes an arcuate lip portion on a back portion thereof that is configured to selectively engage the space defined by the base plate and the retention bracket. Optionally, the stem portion protrudes from the base plate through the retention bracket. Preferably, the stem portion protrudes through a front portion of the decorative head piece.

### CROSS-REFERENCE TO RELATED APPLICATION(S)

The present patent application/patent is a continuation-in-part of co-pending U.S. patent application Ser. No. 12/508,739, filed on Jul. 24, 2009, and entitled “DOOR STOP ASSEMBLY HAVING AN INTERCHANGEABLE DECORATIVE HEAD PIECE,” which claims the benefit of priority of U.S. Provisional Patent Application No. 61/084,004, filed on Jul. 28, 2008, and entitled “DOOR STOP ASSEMBLY HAVING AN INTERCHANGEABLE DECORATIVE HEAD PIECE,” the contents of both of which are incorporated in full by reference herein.

### FIELD OF THE INVENTION

The present invention relates generally to a door stop assembly that includes a retention mechanism and an interchangeable decorative head piece.

### BACKGROUND OF THE INVENTION

A variety of functional and decorative door stop assemblies exist in the art. These door stop assemblies typically consist of relatively simple screw-in pedestal assemblies (solid or spring) that may or may not have a decorative end portion. Alternatively, these door stop assemblies consist of various relatively complex mechanisms that are affixed to a door or the floor and that do not have a decorative portion. In some cases, mechanisms that are affixed to a door act in conjunction with mechanisms that are affixed to the floor. In any case, the door stop assemblies prevent a door (and especially a door handle) or the like from hitting and damaging an adjacent wall.

What is still needed in the art, however, is a door stop assembly that prevents a door (and especially a door handle) or the like from hitting and damaging an adjacent wall, while providing an interchangeable decorative head piece, such that the door stop assembly may be used to enhance the décor of a room. Preferably, this door stop assembly would be relatively inexpensive to manufacture and relatively simple to install, with the interchangeable decorative head piece being relatively simple to replace.

### BRIEF SUMMARY OF THE INVENTION

In various exemplary embodiments, the present invention provides a door stop assembly that prevents a door (and especially a door handle) or the like from hitting and damaging an adjacent wall, while providing an interchangeable decorative head piece, such that the door stop assembly may be used to enhance the décor of a room. Advantageously, this door stop assembly is relatively inexpensive to manufacture and relatively simple to install, with the interchangeable decorative head piece being relatively simple to replace.

In one exemplary embodiment, the present invention provides a door stop assembly that includes a retention mechanism that is releasably secured to a portion of a structure; and a decorative head piece that is releasably secured and engaged to the retention mechanism. Optionally, the retention mechanism includes a track on which a recess defined by the decorative head piece is selectively slid, thereby coupling the decorative head piece to the retention mechanism. The retention mechanism is releasably secured to a wall or a floor of the structure. Alternatively, the retention mechanism includes a flange that is integrally formed with the decorative head piece, wherein the flange is configured to receive one or more screws.

In another exemplary embodiment of the present invention, a door stop assembly that includes a retention mechanism that is releasably secured to a portion of a structure, a decorative head piece that is releasably secured to the retention mechanism, and a coacting means for releasably securing the decorative head piece to the retention mechanism.

In yet another exemplary embodiment of the present invention, a door stop assembly that includes coacting means comprises a track disposed on the retention mechanism on which a recess defined by the decorative head piece is selectively slid, thereby coupling the decorative head piece to the retention mechanism.

In yet another exemplary embodiment of the present invention, a door stop assembly that includes a retention mechanism is selectively affixed one of directly and indirectly adjacent to one of a wall and a floor of the structure.

In yet another exemplary embodiment of the present invention, a door stop assembly that includes a retention mechanism that comprises a flange that is integrally formed with the decorative head piece, wherein the flange is configured to receive one or more screws.

In yet another exemplary embodiment of the present invention, a door stop assembly that includes a retention mechanism that comprises a flange that is integrally formed with the decorative head piece, wherein the flange includes a threaded bore for receiving a correspondingly threaded screw.

In yet another exemplary embodiment of the present invention, a door stop assembly that includes a collar that secures the dove-tailed recess securely in place.

In yet another exemplary embodiment of the present invention, a door stop assembly that includes a cavity for receiving and concealing the flange.

In yet another exemplary embodiment of the present invention, a door stop assembly that includes a retention mechanism that has a front portion and a back portion, an interchangeable head piece having a front portion and a back portion, and a coacting means. The coacting means includes a dove-tailed track defined by the back portion of the interchangeable head piece, and a dove-tailed recess defined by the back portion of the retention mechanism. The dove-tailed track is configured to selectively slidingly engage the dove-tailed recess forming a releasably engaged assembly.

In yet another exemplary embodiment of the present invention, a method for preventing a door from damaging an adjacent structure that includes providing a retention mechanism that is selectively affixed one of directly and indirectly adjacent to a portion of a structure, securing the retention mechanism to a wall adjacent a door, providing a decorative head piece, and securing the decorative head piece to the retention mechanism.

In yet another exemplary embodiment of the present invention, a method for preventing a door from damaging an adjacent structure that includes providing a retention mechanism that comprises a coacting means for releasably securing the decorative head piece to the retention mechanism.

In yet another exemplary embodiment of the present invention, a method for preventing a door from damaging an adjacent structure that includes providing a coacting means that comprises a track on which a recess defined by the decorative head piece is selectively slid, thereby coupling the decorative head piece to the retention mechanism.

In yet another exemplary embodiment of the present invention, a method for preventing a door from damaging an adjacent structure that includes releasably securing the retention member to a baseboard adjacent the door.

In yet another exemplary embodiment of the present invention, a method for preventing a door from damaging an adjacent structure that includes screwing the retention mechanism into the adjacent structure, which is a baseboard.

In yet another exemplary embodiment of the present invention, a method for preventing a door from damaging an adjacent structure that includes providing a flange that is integrally formed with the decorative head piece, providing a bore within flange for receiving one or more screws, and screwing the screws into the bore.

In yet another exemplary embodiment of the present invention, a method for preventing a door from damaging an adjacent structure that includes providing a decorative head piece that is a black bear.

In yet another exemplary embodiment of the present invention, a method for preventing a door from damaging an adjacent structure that includes providing a cavity for receiving and concealing the flange.

In yet another exemplary embodiment, the present invention provides a door stop assembly having an interchangeable decorative head piece, including: a base plate that is selectively secured to the base of a wall; a retention bracket that is selectively secured to the base plate; a stem portion that protrudes from the retention bracket; and a decorative head piece that is selectively secured to the retention bracket. Optionally, the base plate and the retention bracket are integrally formed. Optionally, the base plate and the retention bracket define a space there between. The decorative head piece includes an arcuate lip portion on a back portion thereof that is configured to selectively engage the space defined by the base plate and the retention bracket. Optionally, the stem portion protrudes from the base plate through the retention bracket. Preferably, the stem portion protrudes through a front portion of the decorative head piece.

In yet another exemplary embodiment, the present invention provides a method for providing a door stop assembly having an interchangeable decorative head piece, including: providing a base plate that is selectively secured to the base of a wall; providing a retention bracket that is selectively secured to the base plate; providing a stem portion that protrudes from the retention bracket; and providing a decorative head piece that is selectively secured to the retention bracket. Optionally, the base plate and the retention bracket are integrally formed. Optionally, the base plate and the retention bracket define a space there between. The decorative head piece includes an arcuate lip portion on a back portion thereof that is configured to selectively engage the space defined by the base plate and the retention bracket. Optionally, the stem portion protrudes from the base plate through the retention bracket. Preferably, the stem portion protrudes through a front portion of the decorative head piece.

### BRIEF DESCRIPTION OF THE DRAWINGS

The present invention is illustrated and described herein with reference to the various drawings, in which like reference numbers are used to denote like assembly components/method steps, as appropriate, and in which:

FIG. 1 is a planar side view illustrating one exemplary embodiment of the door stop assembly of the present invention, including one exemplary embodiment of both the retention mechanism and interchangeable decorative head piece of the present invention in an unassembled state;

FIG. 2 is a planar top view of the door stop assembly of FIG. 1, also in an unassembled state;

FIG. 3 is a planar side view illustrating another exemplary embodiment of the door stop assembly of the present invention, including another exemplary embodiment of both the retention mechanism and interchangeable decorative head piece of the present invention in an unassembled state;

FIG. 4 is a planar top view of the door stop assembly of FIG. 3, also in an unassembled state;

FIG. 5 is a planar side view illustrating a further exemplary embodiment of the door stop assembly of the present invention, including a further exemplary embodiment of both the retention mechanism and interchangeable decorative head piece of the present invention in an unassembled state;

FIG. 6 is a planar top view of the door stop assembly of FIG. 5, also in an unassembled state;

FIG. 7 is a perspective view of a still further exemplary embodiment of the door stop assembly of the present invention, highlighting the stem assembly; and

FIG. 8 are perspective and rear planar views of a still further exemplary embodiment of the door stop assembly of the present invention, highlighting the decorative head piece.

### DETAILED DESCRIPTION OF THE INVENTION

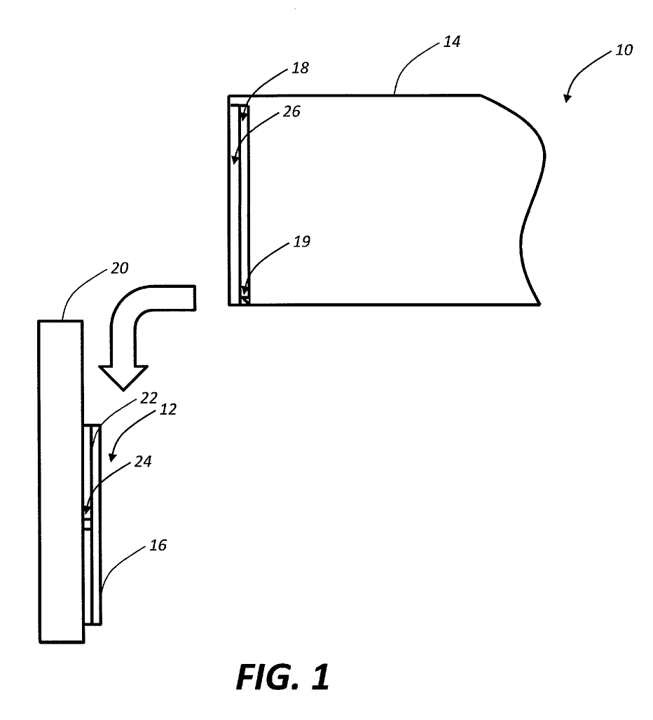

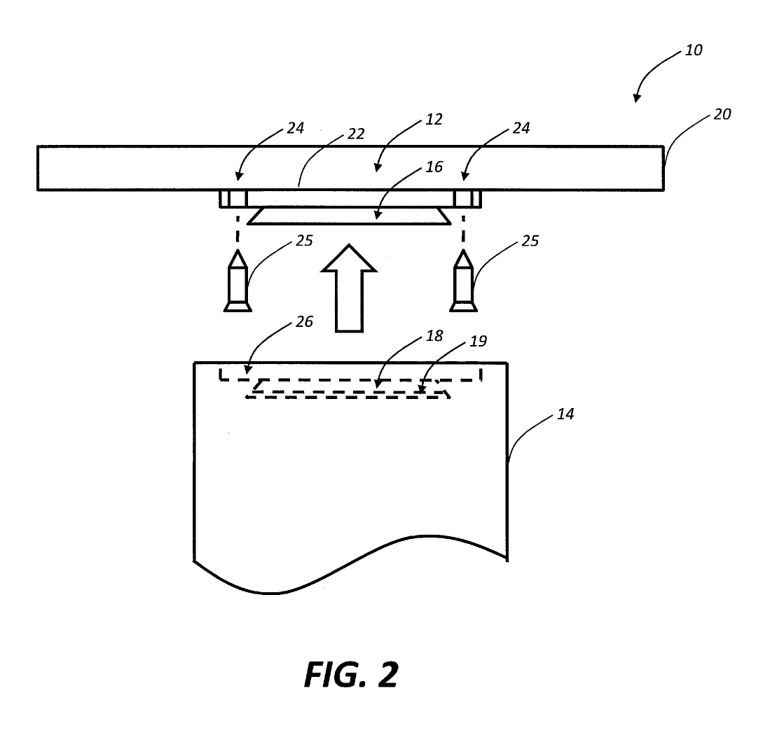

Referring now specifically to the drawings, a door stop assembly according to a preferred embodiment of the present invention is illustrated in FIGS. 1 and 2 and is shown generally at reference numeral 10. The door stop assembly 10 generally comprises a retention mechanism 12, having a front portion and a back portion, and a decorative head piece 14, having a front portion and a back portion. The retention mechanism 12 comprises a dove-tailed track 16. The decorative head piece 14 comprises a dove-tailed recess. The dove-tailed track 16 is configured to selectively slidingly engage the corresponding dove-tailed recess 18 defined by the back portion of the interchangeable decorative head piece 14. The dove tailed track 16 and dove tailed recess 18 are collectively a coacting means, and specifically a means for releasably securing the retention mechanism 12 and decorative head piece 14.

Specifically, FIG. 1 is a planar side view illustrating one exemplary embodiment of the door stop assembly 10 of the present invention, including one exemplary embodiment of both the retention mechanism 12 and interchangeable decorative head piece 14 of the present invention in an unassembled state. FIG. 2 is a planar top view of the door stop assembly 10 of FIG. 1, also in an unassembled state.

Referring to FIGS. 1 and 2, the dove-tailed recess 18 may include a collar 19, which is a raised structure or “bump” for holding the dove-tailed recess 18 securely in place relative to the dove-tailed track 16 once engaged. The dove-tailed track may be adapted for attachment to a support structure. In one exemplary embodiment, the dove-tailed track 16 is selectively coupled to the baseboard 20 of a wall or other structural element. Preferably, the dove-tailed track 16 is selectively coupled to the baseboard 20 in close proximity to a door, for preventing the door and attached door knob from damaging the structure.

The back portion of the interchangeable decorative head piece 14 may include a flange 22 that defines one or more holes 24 that are each configured to receive a wood screw 25 (FIG. 2) or the like. Preferably, the back portion of the interchangeable decorative head piece 14 includes a cavity 26 that is configured to receive and conceal the flange 22. Advantageously, the interchangeable decorative head piece 14 may have any aesthetic appearance. For example, it may be shaped like a duck, a deer head, black bear, etc., thereby complimenting the décor of a room or the like. It will be readily apparent to those of ordinary skill in the art, however, that other retention mechanism and/or interchangeable decorative head piece designs may be employed to accomplish similar purposes and/or achieve like results. Advantageously, the interchangeable decorative head piece 14 inherently covers the wood screws 25 once they have been placed, thereby enhancing the aesthetic appearance of the door stop assembly 10.

In another embodiment, the back portion of the interchangeable decorative head piece 14 may include a flange 22 that includes one or more holes 24 that are threaded. The threads disposed within the one or more holes 24 is designed to easily receive a wood screw 25 or the like. Further, the threads provide for a retention force that aids in securing the decorative head piece 14 to the retention mechanism 12.

Although a coacting means such as a dove-tailed track 16 and recess 18 have been illustrated and described herein, it is contemplated that other engaging structures could be utilized, such as an inverse dove-tailed assembly, like that used in conjunction with bathroom towel bars, and the like. In this arrangement, the retention mechanism 12 and the decorative head piece 14 contain a coacting means on the upper portion of the respective back portion. The coacting means is adapted to receive and engage both the retention mechanism 12 and the decorative head piece 14 forming a releasably secure arrangement. In the releasably secure arrangement the decorative head piece is prevented from moving downwardly relative to the retention mechanism 12. In one embodiment, the alternative embodiment contains a pair of hooks on the retention mechanism for receiving and engaging the decorative head piece 14.

In another embodiment, the coacting means includes a retention mechanism 12 having an arcuate top portion and an arcuate flange. The decorative head piece 14 contains an arcuate cavity on the top portion for receiving the arcuate flange. During use, the retention mechanism 12 is affixed to a structure, such as the baseboard or wall, and the decorative head piece 14 is slide in a downward fashion until the arcuate cavity of the decorative head piece 14 engages the arcuate flange of the retention mechanism 12, forming a releasably secure arrangement. In the releasably secure arrangement, the decorative head piece 14 is prevented from moving downwardly relative to the retention mechanism 12. Further, a threaded bore is disposed on the bottom portion of the retention mechanism 12 and a correspondingly threaded bore is disposed on the decorative head piece 14. The threaded bores are designed for receiving a correspondingly threaded screw, whereby the threaded screw is rotated within the threaded bores for further securing the decorative head piece 14 to the retention mechanism 12.

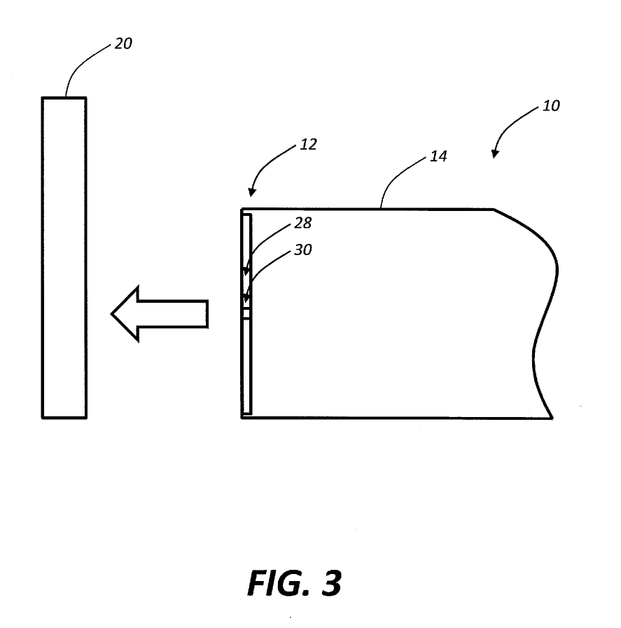

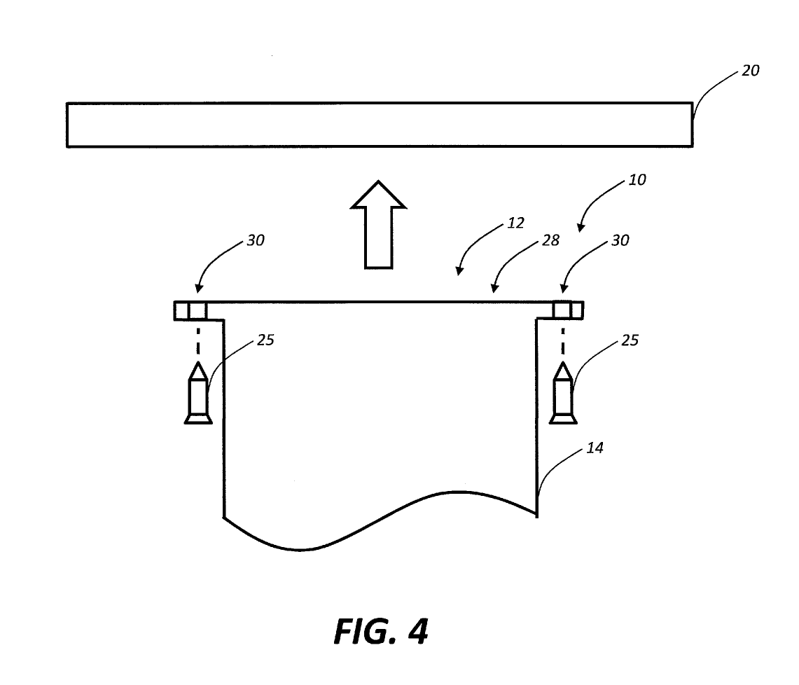

FIG. 3 is a planar side view illustrating another exemplary embodiment of the door stop assembly 10 of the present invention, including another exemplary embodiment of both the retention mechanism 12 and interchangeable decorative head piece 14 of the present invention in an unassembled state. FIG. 4 is a planar top view of the door stop assembly 10 of FIG. 3, also in an unassembled state.

Referring to FIGS. 3 and 4, the retention mechanism 12 includes a flange 28 that defines one or more holes 30 that are each configured to receive a wood screw 25 (FIG. 4) or the like. This flange 28 is fixedly attached to or integrally formed with the interchangeable decorative head piece 14. Again, advantageously, the interchangeable decorative head piece 14 may have any aesthetic appearance. For example, it may be shaped like a duck, a deer head, etc., thereby complimenting the décor of a room or the like. It will be readily apparent to those of ordinary skill in the art, however, that other retention mechanism and/or interchangeable decorative head piece designs may be employed to accomplish similar purposes and/or achieve like results. Optionally, the interchangeable decorative head piece 14 includes one or more hinged covers or plugs (not illustrated) that are used to selectively cover the wood screws 25 once they have been placed, thereby enhancing the aesthetic appearance of the door stop assembly 10. As illustrated in FIG. 3, the retention mechanism 14 is a generally square shape. However, it will be apparent to one of ordinary skill in the art that the retention mechanism 14 may be any shape, such as generally rectangular, V-shaped, or the like.

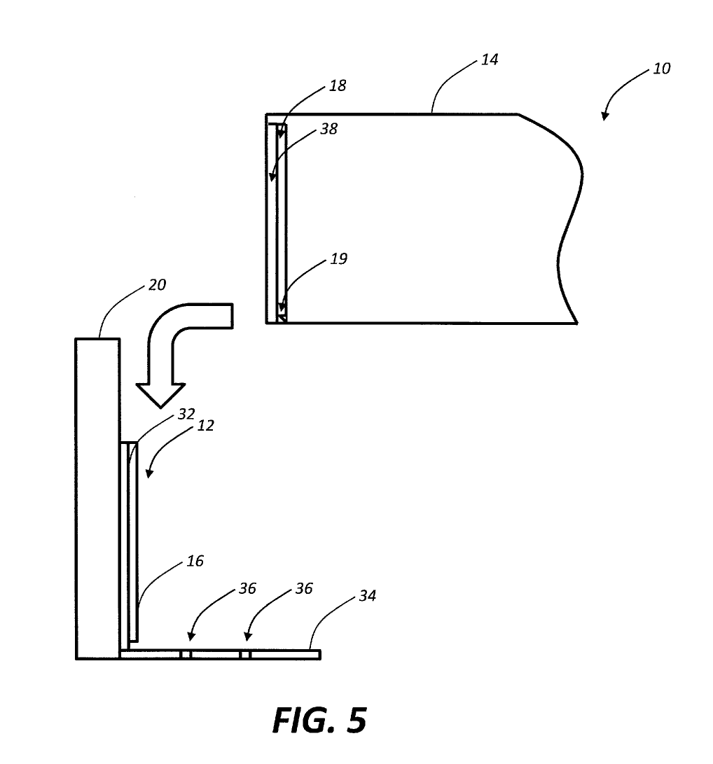

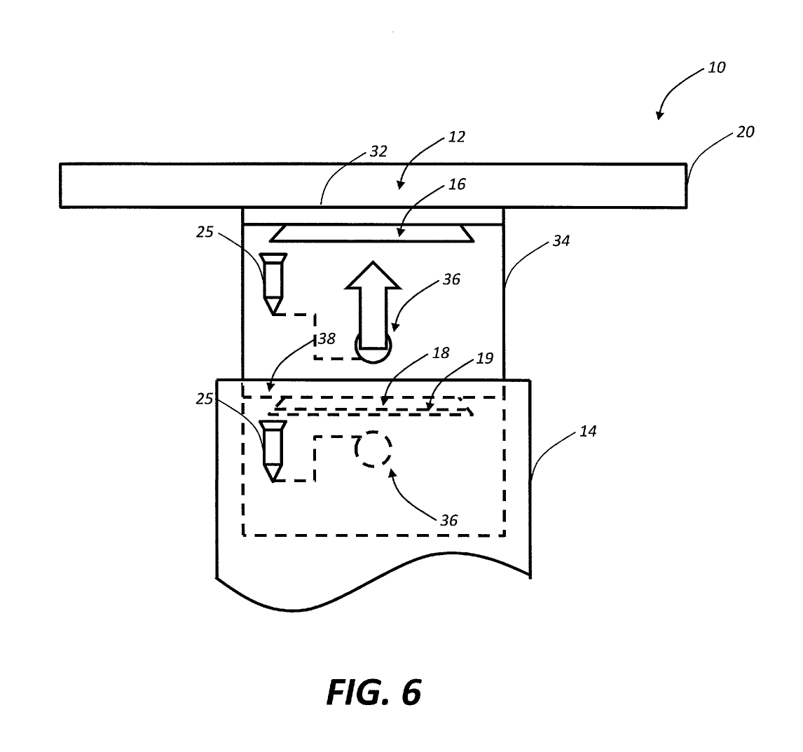

FIG. 5 is a planar side view illustrating a further exemplary embodiment of the door stop assembly 10 of the present invention, including a further exemplary embodiment of both the retention mechanism 12 and interchangeable decorative head piece 14 of the present invention in an unassembled state. FIG. 6 is a planar top view of the door stop assembly 10 of FIG. 5, also in an unassembled state.

Referring to FIGS. 5 and 6, the retention mechanism 12 includes a dove-tailed track 16 that is configured to selectively slidingly engage a corresponding dove-tailed recess 18 defined by the back portion of the interchangeable decorative head piece 14. Optionally, the dove-tailed recess 18 includes a raised collar 19 that holds the dove-tailed recess 18 securely in place relative to the dove-tailed track 16 once engaged. The dove-tailed track 16 is releasably secured to the floor of a structure, as opposed to the baseboard 20 of a wall or other structural element, either adjacent to or spaced apart from the baseboard 20 of the wall or other structural element, via a flange 32 that is coupled to a mounting bracket 34 that defines one or more holes 36 that are each configured to receive a wood screw 25 (FIG. 6) or the like. Preferably, the back portion of the interchangeable decorative head piece 14 includes a cavity 38 that is configured to receive and conceal the flange 32. Again, advantageously, the interchangeable decorative head piece 14 may have any aesthetic appearance. For example, it may be shaped like a duck, a deer head, etc., thereby complimenting the décor of a room or the like. It will be readily apparent to those of ordinary skill in the art, however, that other retention mechanism and/or interchangeable decorative head piece designs may be employed to accomplish similar purposes and/or achieve like results. Advantageously, the interchangeable decorative head piece 14 inherently covers the wood screws 25 once they have been placed, thereby enhancing the aesthetic appearance of the door stop assembly 10.

In another alternative embodiment of the present invention, the decorative head piece 14 includes a magnet. The magnet may be positioned on the exterior of the decorative head piece 14 or slightly below the exterior surface of the decorative head piece 14. A piece of metal or an attractive magnet may be affixed to an adjacent door, whereby the decorative head piece 14 and retention mechanism 12 are affixed to an adjacent wall. The piece of metal or attractive magnet may be affixed to the door in any way known to one of ordinary skill in the art. Preferably, the piece of metal or attractive magnet contains an adhesive back portion that can be affixed to the door. Prior to use, a wax paper or the like covers the adhesive portion until the user desires to affix the piece of metal or attractive magnet to the door. The user then removes the wax paper from the adhesive portion, thus exposing the adhesive portion for affixing to a door. The purpose of this embodiment is to create a magnetic attraction between the decorative head piece 14 and the piece of metal or attractive magnet. Optimally, this embodiment would be used with doors that for one reason or another attempt to close on their own. The attractive forces between the decorative head piece and the piece of metal or attractive magnet on the door prevent the door from closing unexpectedly.

In another embodiment of the present invention, a light is incorporated into the decorative head piece 14. The decorative head piece 14 may be equipped with at least one rechargeable battery providing power to the light. Alternatively, any battery may be utilized to provide power to the light. Preferably, two 12 volt batteries, arranged in series, are utilized to provide power to the light. The batteries may be recharged with any standard, commercially available recharging device, or the batteries may be recharged via an electrical connector that receives power from an external power source, and can either recharge the batteries or provide power to the light.

In yet another alternative embodiment of the present invention, the decorative head piece 14 is equipped with both a light and a sensor. The sensor is able to detect the light level in the room, thus acting as a switch to turn the light on and off depending upon the level of ambient light. For example, when the sensor detects that enough light is present in the room, allowing one to see adequately, the sensor is in the off position and the light is off. When the sensor detects that there is not ample light in the room, the sensor switches from the off position to the on position and the light is turned on. In this embodiment, the decorative head piece 14 may be equipped with at least one rechargeable battery providing power to the light and sensor. Alternatively, any battery may be utilized to provide power to the light and sensor. Preferably, two 12 volt batteries, arranged in series, are utilized to provide power to the light and sensor. The batteries may be recharged with any standard, commercially available recharging device, or the batteries may be recharged via an electrical connector that receives power from an external power source, and can either recharge the batteries or power the light and sensor.

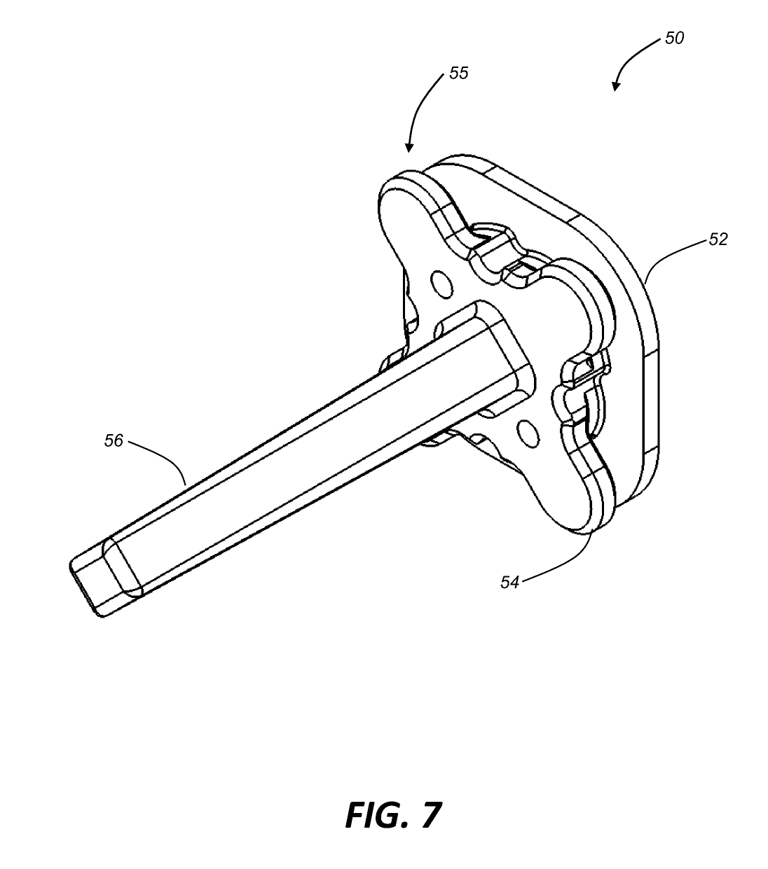

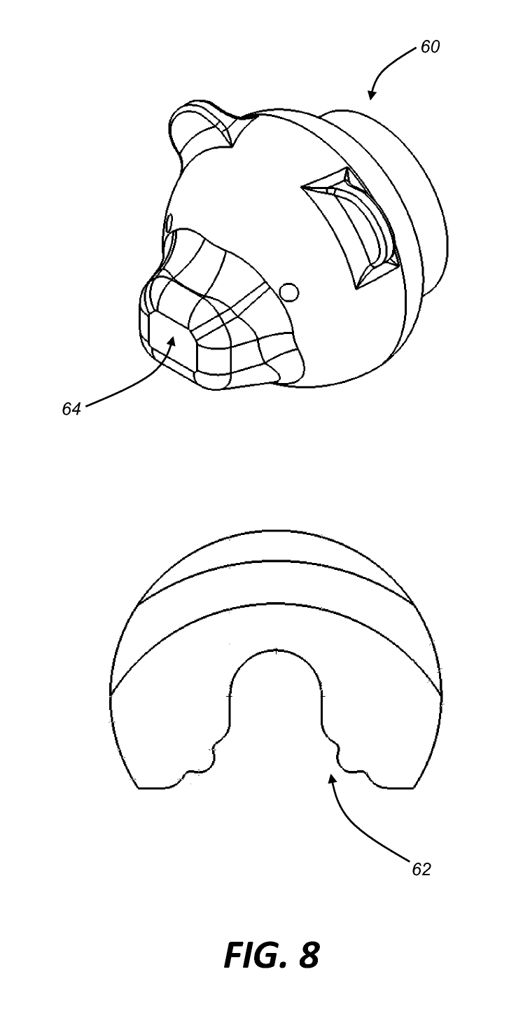

Referring now to FIG. 7, in yet another exemplary embodiment of the present invention the door stop assembly 50 includes a base plate 52 that is selectively secured to the base of a wall, such as by screws, other mechanical fasteners, an adhesive, and/or the like. A retention bracket 54 is selectively secured to the base plate 52, again by a slotted track, screws, other mechanical fasteners, an adhesive, and/or the like. A space is created between the base plate 52 and a plurality of retention members 55 of the retention bracket 54. This space is configured to selectively receive and retain the decorative head piece 60 (FIG. 8) to the retention bracket 54 and base plate 52. A stem portion 56 protrudes from the retention bracket 54 or, alternatively, from the base plate 52 through the retention bracket 54.

Referring now to FIG. 8, the decorative head piece 60 (in this case a bear head piece is illustrated) is at least partially hollow, and a back portion of the decorative head piece 60 forms an arcuate lip portion 62 that is configured to selectively engage the space created between the base plate 52 (FIG. 7) and the plurality of retention members 55 (FIG. 7) of the retention bracket 54 (FIG. 7). Part of the front portion of the decorative head piece 60 forms a cut-away 64 through which the stem portion 56 of the retention bracket 54 passes.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A door stop assembly having an interchangeable decorative head piece, comprising:
a base plate that is selectively secured to the base of a wall;
a retention bracket that is selectively secured to the base plate;
a stem portion that protrudes from the retention bracket; and
a decorative head piece that is selectively secured to the retention bracket.

2. The door stop assembly of claim 1, wherein the base plate and the retention bracket are integrally formed.

3. The door stop assembly of claim 1, wherein the base plate and the retention bracket define a space there between.

4. The door stop assembly of claim 3, wherein the decorative head piece comprises an arcuate lip portion on a back portion thereof that is configured to selectively engage the space defined by the base plate and the retention bracket.

5. The door stop assembly of claim 1, wherein the stem portion protrudes from the base plate through the retention bracket.

6. The door stop assembly of claim 1, wherein the stem portion protrudes through a front portion of the decorative head piece.

7. A method for providing a door stop assembly having an interchangeable decorative head piece, comprising:
providing a base plate that is selectively secured to the base of a wall;
providing a retention bracket that is selectively secured to the base plate;
providing a stem portion that protrudes from the retention bracket; and
providing a decorative head piece that is selectively secured to the retention bracket.

8. The method for providing a door stop assembly of claim 7, wherein the base plate and the retention bracket are integrally formed.

9. The method for providing a door stop assembly of claim 7, wherein the base plate and the retention bracket define a space there between.

10. The method for providing a door stop assembly of claim 9, wherein the decorative head piece comprises an arcuate lip portion on a back portion thereof that is configured to selectively engage the space defined by the base plate and the retention bracket.

11. The method for providing a door stop assembly of claim 7, wherein the stem portion protrudes from the base plate through the retention bracket.

12. The method for providing a door stop assembly of claim 7, wherein the stem portion protrudes through a front portion of the decorative head piece.
